(19) United States
(12) Patent Application Publication
(10) Pub. No.: US 2014/0326210 A1
(43) Pub. Date: Nov. 6, 2014

(54) ROTARY ENGINE ARRANGEMENT

(71) Applicant: Gilo Industries Research Ltd., Dorset (GB)

(72) Inventor: Gilo Cardozo, Dorset (GB)

(73) Assignee: Gilo Industries Research Ltd., Dorset (GB)

(21) Appl. No.: 14/066,065

(22) Filed: Oct. 29, 2013

(30) Foreign Application Priority Data
May 1, 2013 (GB) 1307901.7

(51) Int. Cl. F02B 55/02; F02B 53/14

(52) U.S. Cl. CPC F02B 55/02; F02B 53/14
USPC 123/200; 418/54

(57) ABSTRACT

An oil cooled rotary engine comprising a centrally mounted timing gear arrangement. A stationary gear is mounted on a stationary shaft positioned concentrically with the output shaft of the engine. A rotary engine comprising a coaxially positioned expander unit.

### CROSS REFERENCE TO RELATED APPLICATION

This application is a non-provisional application claiming priority from UK Application No. 1307901.7 filed on May 1, 2013, incorporated herein by reference in its entirety.

### FIELD OF THE DISCLOSURE

The present description relates generally to rotary engines, and more particular to a rotary engine arrangement.

### BACKGROUND OF RELATED ART

In a number of applications rotary internal combustion engines (for example, the Wankel layout) provide an attractive alternative to the more commonly utilized reciprocating piston engine.

In a rotary engine a rotor is mounted eccentrically on an output shaft. The rotor is geared to the shaft such that rotation of the output shaft causes eccentric rotation of the rotor, and vice versa. For example, a Wankel engine uses a three-side (approximately triangular) rotor within an epitrochoidal chamber.

FIG. 1 shows a cross section through the output shaft of a conventional rotary engine. An epitrochoidal chamber is defined by chamber wall 10 and parallel, flat, chamber side plates 11, 12. An output shaft 13 runs through the chamber and comprises an eccentric portion 14. A three-sided rotor 15 is mounted on the eccentric portion 14 via a bearing 16 such that the rotor 15 can rotate with respect to the output shaft 13 which in turn is rotatable with respect to the chamber side plates 11, 12. A stationary gear 17 is mounted to the end plate 12 and protects laterally into the interior of the rotor 15. A ring gear 18 is formed on the interior of the rotor 15 and is configured to mesh with the stationary gear 17 at the point of closest approach between the rotor 15 and output shaft 13. This arrangement allows eccentric movement of the rotor 15 within the chamber. As the rotor 15 moves within the chamber, combustion chambers are formed between the faces of the rotor and the chamber wall. The combustion, and hence expansion, of fuels within those combustion chambers transfers forces to the rotor which are transferred as rotational forces to the output shaft by the gears 17, 18 and eccentric portion 14.

Lubrication and cooling of the components in the interior of the rotor is a challenge. A conventional arrangement is to provide an oil feed through the output shaft to direct oil to the rotor bearing 16 which also lubricates the stationary gear 17 and ring gear 18 before being collected and exiting along the output shaft. A difficulty of this arrangement is that the rotor side seals must contain the oil within the rotor. Even with suitable scraper rings a film of oil remains on the chamber side plates 11, 12 which is burnt during each combustion cycle. Oil consumption is thus high and output pollution poor.

Other methods of cooling and lubrication, for example utilizing lateral airflow with an entrained fuel/oil mix through the rotor (as used in a reciprocating two-stroke engine), have also been utilized but do not allow the use of shell bearings, and also present pollution disadvantages.

There is therefore a requirement for a rotary engine having an improved lubrication system.

The embodiments described below are not limited to implementations that solve any or all of the disadvantages of known publish/subscribe systems.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

There is provided a rotary internal combustion engine, comprising an output shaft rotationally mounted in two parallel chamber side plates, the side plates and a chamber wall defining a cavity through which the output shaft runs, the output shaft comprising an eccentric portion positioned between the side plates within the cavity, the eccentric portion comprising a slot extending into the eccentric portion from the face of the eccentric portion in the region of the eccentric portion's smallest radius, a stationary shaft positioned concentrically within the output shaft and extending from a distal end of the output shaft outside of the chamber to the slot in the eccentric portion, the stationary shaft being mounted to be stationary with respect to the chamber side plates, a stationary gear mounted on the stationary shaft in the slot in the eccentric portion, and a rotor rotationally mounted on the eccentric portion of the output shaft, the rotor comprising an internal gear configured to mesh with the stationary gear.

There is also provided a rotary internal combustion engine, comprising an output shaft rotationally mounted in two parallel combustion chamber side plates, the combustion chamber side plates and a combustion chamber wall defining a combustion chamber through which the output shaft runs, the output shaft comprising an eccentric portion positioned between the combustion chamber side plates within the combustion chamber, a combustion stationary gear positioned within the combustion chamber coaxial with the output shaft, the combustion stationary gear being stationary with respect to the combustion chamber side plates, a combustion rotor rotationally mounted on the eccentric portion of the output shaft, the combustion rotor comprising an internal gear configured to mesh with the combustion stationary gear, an expander shaft rotationally mounted in two parallel expander chamber side plates, the expander chamber side plates and an expander chamber wall defining an expansion chamber through which the expander shaft runs, the expander shaft comprising an eccentric portion positioned between the expander side plates within the expander cavity, an expander stationary gear positioned within the expander chamber coaxial with the expander shaft, the expander stationary gear being stationary with respect to the expander chamber side plates, an expander rotor rotationally mounted on the eccentric portion of the expander shaft, the expander rotor comprising an internal gear configured to mesh with the expander station gear, wherein the expander shaft and output shaft are coaxial.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 shows a cross-section of a conventional rotary engine;

FIG. 2 shows a cross-section of a rotary engine according to the current disclosure;

FIGS. 3 and 4 show a selection of components of a rotary engine according to the current disclosure;

FIG. 4a shows an end face of a rotor and bearing carrier, and

FIGS. 5 and 6 show a cross-section of a rotary engine having a coaxial rotary expansion system.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

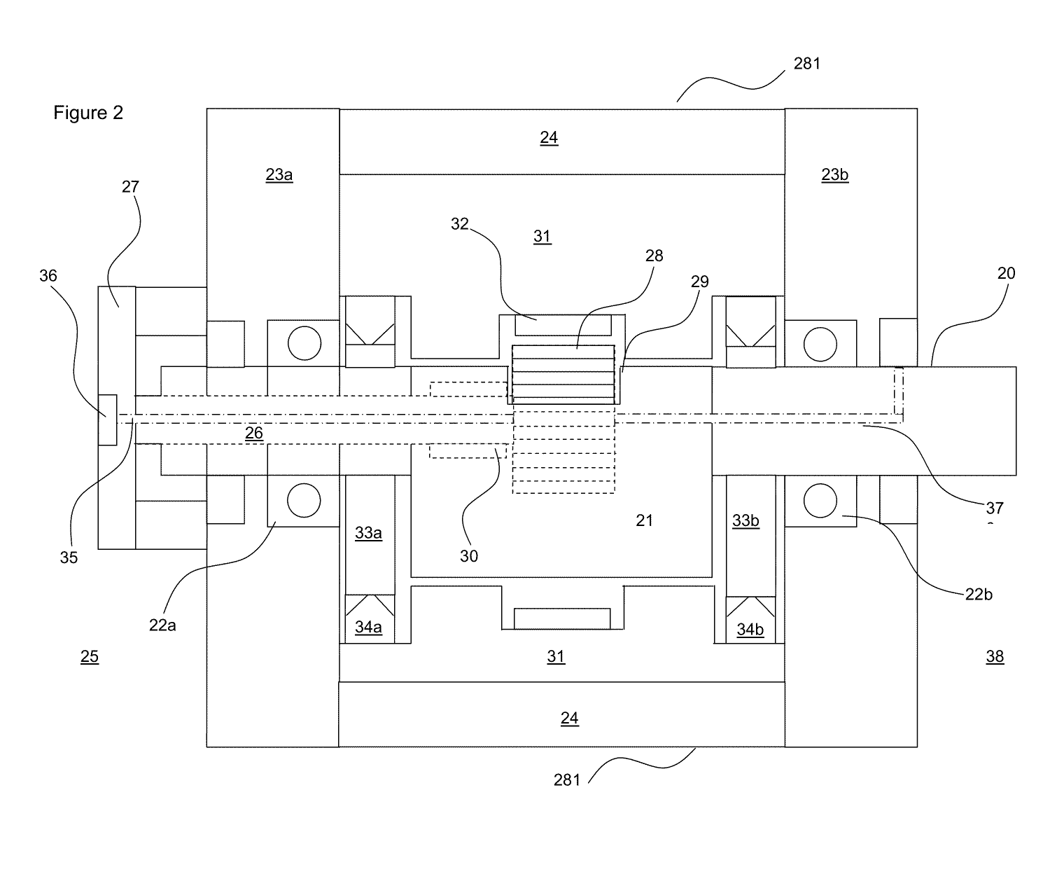

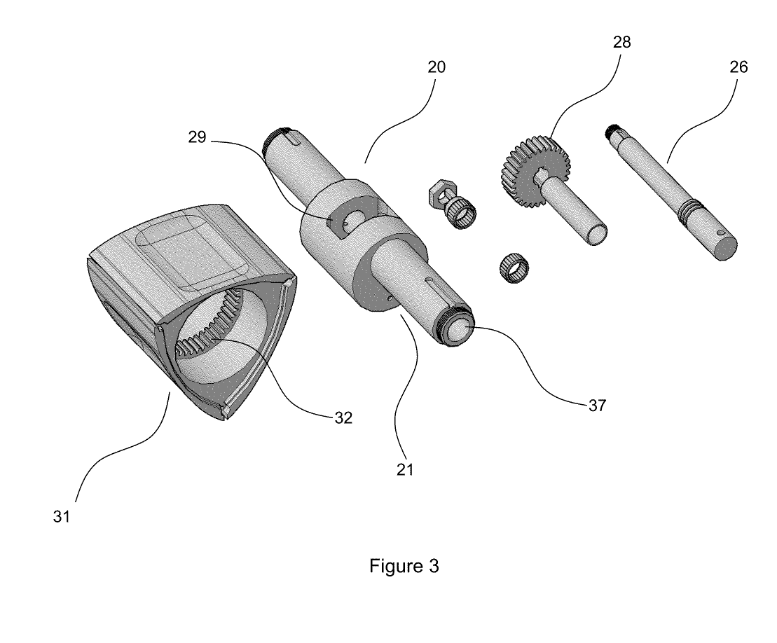

FIG. 2 shows a cross-section through the output shaft of a rotary engine allowing improved lubrication and oil cooling of the interior parts of the rotor. FIG. 3 shows perspective views of a selection of components of the engine of FIG. 2 to better show certain features. The rotor timing gears (the stationary and ring gears) of the engine are positioned centrally allowing the use of rotation-only oil seals. The central positioning of the timing gears also removes the lateral offset of forces through the timing gears and rotor bearings present in conventional engines.

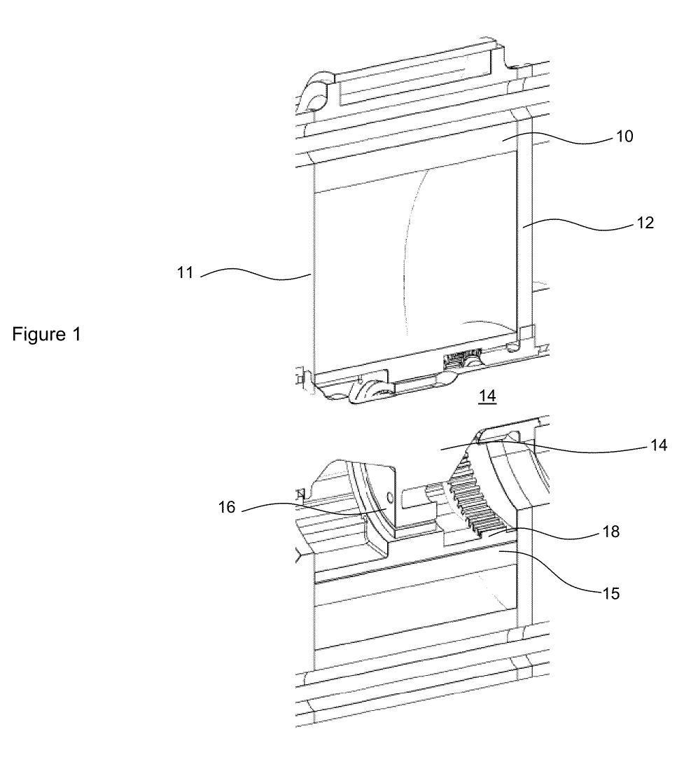

Output shaft 20 comprises an eccentric portion 21 and is mounted by output shaft bearings 22a, 22b in rotor chamber end plates 23a, 23b as described in relation to the engine of FIG. 1. An epitrochoidal rotor chamber 24 is formed by end plates 23a, 23b and rotor chamber wall 281.

The output shaft 20 has an axial hollow extending from a first end 25. A stationary shaft 26 is mounted within the hollow in the output shaft 20 and is held stationary with respect to the end plate 23a by stationary shaft mounting 27. The output shaft 20 is thus concentric with stationary shaft 26. A stationary gear 28 is mounted on the internal end of stationary shaft 26 to lie within a slot 29 in the eccentric portion 21 of the output shaft 20. The slot 29 is circumferentially positioned at the smallest radius of the eccentric potion 21. At least one bearing 30 supports output shaft 20 on stationary shaft 26. This bearing 30 may be a needle roller bearing or other type of bearing suitable for this application.

A rotor 31 is mounted on eccentric portion 21 and runs on bearings on the journal face of eccentric potion 21. The rotor construction and mounting is described in more detail below. Rotor 31 has the same outer geometry as the rotor of the engine of FIG. 1, but the interior ring gear 32 is positioned in the lateral center of the rotor 31 to align with the stationary gear 28. Stationary gear 28 is sized to extend beyond radius of the eccentric portion to mesh with the ring gear 32. Rotor 31 thus runs on bearings on the eccentric portion and is forced to rotate by the station gear 28 and ring gear 32 in the same way as for a conventional rotary engine.

Oil seal carriers 33a, 33b are mounted on output shaft 20 outboard of the eccentric portion 21. Oil seal carriers 33a, 33b are locked to the output shaft 20 to rotate therewith and an oil seal is created between the carriers 33a, 33b and the output shaft 20. Oil seals 34a, 34b are carried by carriers 33a, 33b and create an oil seal between the respective carrier 33a, 33b and the rotor 31. Due to the relative rotation of these parts seals 34a, 34b are of the rotationally sliding type.

The arrangement of gears 28, 32 and seals 34a, 34b creates a sealed region within rotor 31 without requiring oil scraper rings between the rotor and chamber side-plates. Oil is fed into this region via an oil passageway 35 within stationary shaft 26. An opening at the exterior end of the stationary shaft 35 provides an oil inlet 36. Oil outlets are provided at the inboard end of stationary shaft 26 to provide oil to gears 28, 32 and the journal of the eccentric portion 21. The oil outlets may be designed in a conventional manner to ensure oil is directed to all required areas to provide cooling and lubrication. Oil is captured into oil passageway 37 in output shaft 20 and flows to the outboard end 38 of that shaft 20. Oil is fed into inlet 36 and collected from passageway 37 using a conventional pump and circulation system.

The arrangement shown in FIGS. 2 and 3 constrains the oil within the interior of the rotor 27 to lubricate and cool stationary and ring gears 25, 28, the rotor bearings, and the rotor 31 utilizing only rotational oil seals. The oil scraper rings of conventional rotary engines are not therefore required. It is thus possible to oil-cool and lubricate a rotary engine without incurring the oil-burn problems of conventional engines.

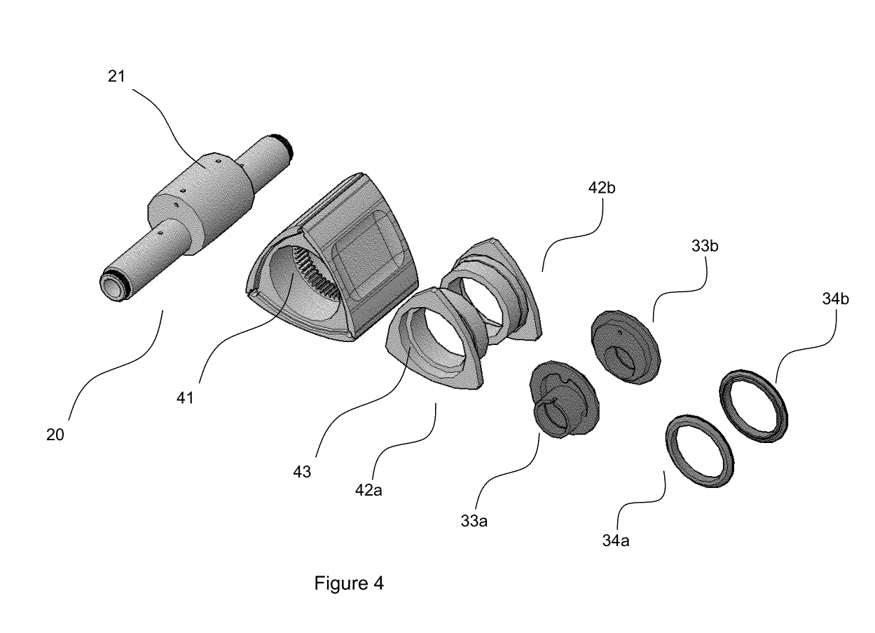

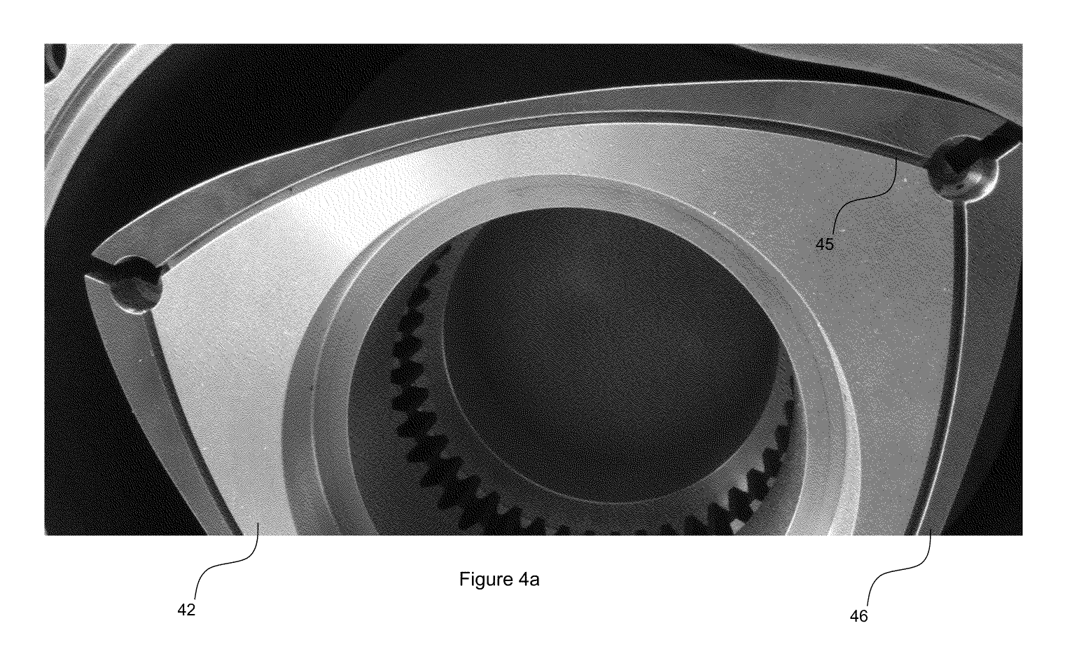

FIG. 4 shows a perspective view of the components of the rotor 31 shown generally in FIGS. 2 and 3. Rotor body 40 is formed with ring gear 41 in the required position within the rotor 40. Bearing carriers 42a, 42b are formed to mount within the ends of the rotor body 40. The bearing carriers are sized to be a press-fit into the rotor such that the rotor rotates with the bearing carrier and is locked both radially and axially thereto. Other methods of locking the rotor to the bearing carriers may be utilized as appropriate. As seen most clearly in FIG. 4a the outer part of the bearing carrier 42 is sized to leave a gap 45 between the bearing carrier 52 and the rotor 46. This gap provides a groove to hold the rotor side seal to seal the combustion chamber against the combustion gasses. The groove may typically have a width of 1 mm. In conventional rotor manufacture the side-seal grooves are formed by machining a groove in the side of the rotor. However, this machining operation is slow, difficult, and expensive due to the small size of the groove. The formation of the groove by the edges of the rotor and bearing carrier therefore simplifies the manufacturing process.

Bearings carriers 42a, 42b carry shell bearings in their internal opening which are sized to run on the journal of eccentric portion 21 of the output shaft 20. The shell bearings are of a conventional type and are lubricated as described above. Bearing carriers 42a, 42b thus mount the rotor on the output shaft 20 to allow rotation of the rotor on the shaft and power delivery to that shaft in the conventional manner. Recess 43 accepts oil seals 34a, 34b carried on carriers 33a, 33b as described and shown hereinbefore.

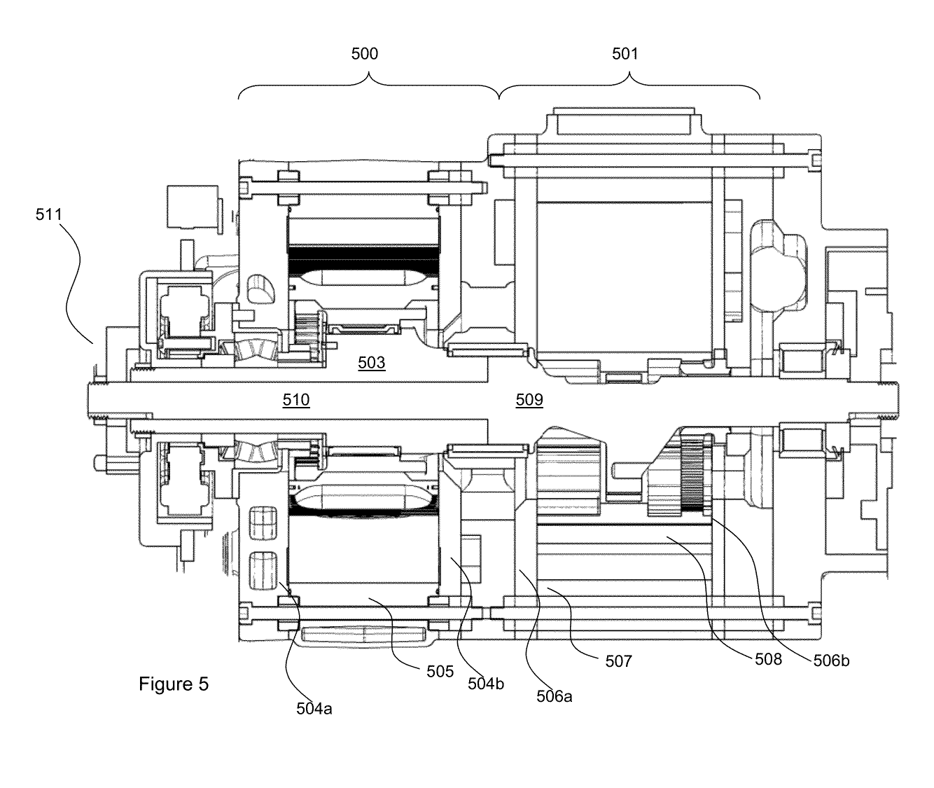

FIG. 5 shows a rotary engine comprising coaxial combustion 500 and exhaust gas expansion 501 systems. The left side of the engine comprises a conventional rotary engine comprising a rotor 502 mounted eccentrically on an output shaft 503. The rotor 502 rotates within a rotor chamber defined by side plates 504a, 504b and rotor chamber wall 505. For example the rotor 502 may be a three sided rotor and the chamber an epitrochoidal chamber.

A second rotor chamber is defined by side plates 506a, 506b and rotor chamber wall 507. This chamber forms an expansion chamber. An expansion rotor 508 is eccentrically mounted on an expansion output shaft 509 for rotation within the expansion chamber. The expansion rotor 508 may be a dual-flanked rotor and the expansion chamber may be a single lobed trochoidal housing.

Output shaft 503 and expansion output shaft 509 are positioned co-axially with one another. An extension part 510 of the expansion output shaft 509 runs through an axial hollow along the length of the output shaft 503 such that for part of the length of the expansion output shaft it is concentric with output shaft 503. The output shaft 503 and expansion output shaft 509, 510 are coupled by coupling mechanism 511 such that they rotate together. Coupling mechanism 511 allows the phase of the two output shafts 503, 509, 510 to be adjusted as required and as explained hereinbelow.

It has been shown that combustion gases from a rotary engine are still expanding upon exhaust even with optimal port timing. The engine of FIG. 5 allows a portion of that expansion energy to be captured. The exhaust of combustion system 500 is fluidly coupled to an inlet of the expansion system, and the outlet of the expansion system forms the exhaust of the engine. Exhaust gasses from the combustion chamber flow into the expansion chamber and by correct timing of the combustion and expansion rotors the exhaust gasses expand against the expansion rotor 508 thereby contributing additional force to the output shaft.

Coupling mechanism 511 allows the phase of the power and expansion rotors to be set thus allowing the timing of the rotor phases to be adjusted to provide optimum performance. This coupling may be dynamic such that the phase can be varied depending on engine operating conditions. For example, as the rotational speed or fuelling of the engine varies exhaust gas flow rates and volumes may vary requiring a different phasing to allow optimum flow and expansion.

If the combustion rotor is a three-faced rotor and the expansion rotor is a two-faced rotor, the gear ratios of the stationary and ring gears of each system are different such that a 3:2 ratio is provided between the rotation speeds of the two rotors. An expansion chamber is thus available for every exhaust phase of the combustion system. If different rotor configurations are utilized different ratios may be provided as appropriate.

The co-axial arrangement of the combustion and expansion shafts provides a compact, simple, and light weight engine arrangement with a number of components shared between the two parts.

The provision of an expansion unit provides a number of performance improvements over a conventional rotary engine, including improved power output, reduced exhaust gas temperature, reduced fuel consumption, and reduced noise output. In initial trials a reduction of 20% in SFC and a reduction of 422 degrees Celsius in exhaust gas temperature.

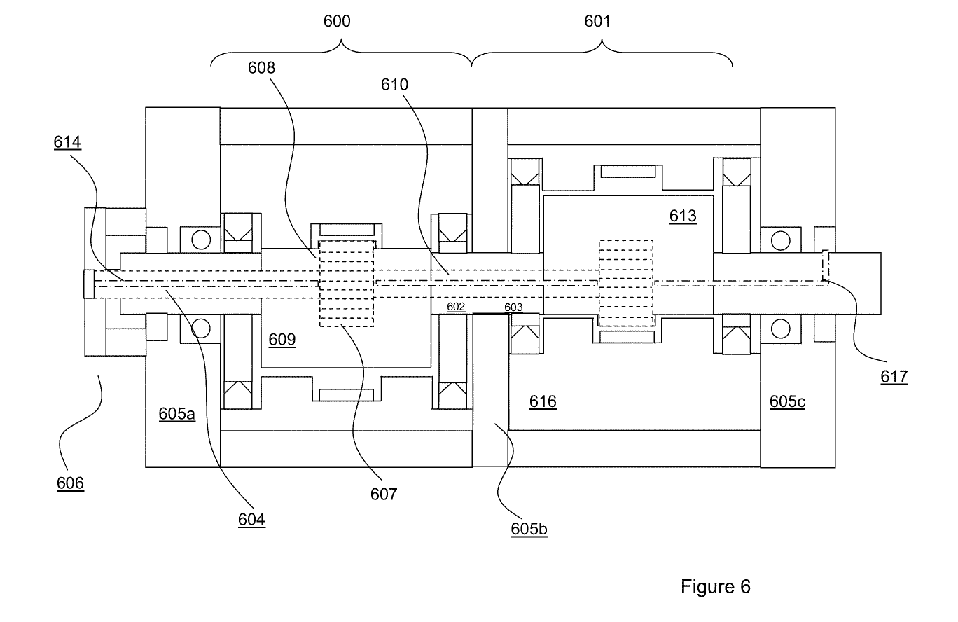

FIG. 6 shows a cross-section of an engine utilizing a combination of the techniques discussed hereinbefore. A combustion system 600 and an expansion system 601 are positioned coaxially as described in relation to FIG. 5. Although not shown, output shaft 602 and expansion output shaft 603 are coupled as described in relation to FIG. 5. A stationary shaft 604 is positioned within the output shafts 602, 603 and held stationary with respect to the engine side plates 605a, 605b, 605c by mounting 606. Output shafts 602, 603 may be mounted on stationary shaft using suitable bearings as described hereinbefore. Combustion stationary gear 607 is mounted on stationary shaft 604 and lies within a slot 608 in the eccentric portion 609 of the combustion output shaft 604. Stationary shaft 604 continues 610 to expander system 601. An expander stationary gear 611 mounted on that shaft and lies within slot 612 in eccentric portion 613 of expander output shaft 603. Combustion rotor 615 and expander rotor 616 are configured as described with reference to FIG. 4.

An oil passageway 614 is defined within stationary shaft 604, 610 with suitable outlets to direct oil to the interior of the combustion rotor 615 and expander rotor 616. Oil passageway 617 is defined in expander output shaft 603 and provides an outlet route for oil pumped to the oil passageway. With a suitable oil circulation system passageways 614, 617 allow oil cooling and lubrication of the rotor gears and rotor bearings as described hereinbefore.

The engine of FIG. 6 thus benefits from the improvements enabled by the central mounting of the stationary gears, and also the improvements provided by the co-axial rotary expansion chamber.

In the foregoing description the combustion and expansion output shafts have been shown and described as running concentrically within one another to enable them to be coupled at an external end. As will appreciated this is only one possible mechanical arrangement for providing two coaxial shafts. For example, the shafts could be formed as a single shaft, but this would remove the possibility of adjusting the phasing of the two shafts. Alternatively two coaxial shafts may be joined end-to-end with a coupling between the combustion and expansion systems of the engine.

Metal Matrix Composite materials may provide a particularly appropriate material for fabrication of the rotors of the engines described hereinbefore.

The oil passageways of the above disclosure are shown positioned along the axis of the relevant shaft, but this is for example only and those passageways may be positioned in any desired location with the shaft. Furthermore, multiple passageways may be utilized as appropriate. For example, flow and return passageways may be provided in a single shaft. The flow path of FIG. 1 is through the stationary shaft, with the return path through the output shaft. This relationship may be reversed, or both flow and return may be provided in one of those shafts. Similarly with reference to FIG. 6 distinct paths may be provided for the combustion and expander rotors.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. A rotary internal combustion engine, comprising
an output shaft rotationally mounted in two parallel chamber side plates, the side plates and a chamber wall defining a cavity through which the output shaft runs, the output shaft comprising an eccentric portion positioned between the side plates within the cavity, the eccentric portion comprising a slot extending into the eccentric portion from the face of the eccentric portion in the region of the eccentric portion's smallest radius,
a stationary shaft positioned concentrically within the output shaft and extending from a distal end of the output shaft outside of the chamber to the slot in the eccentric portion, the stationary shaft being mounted to be stationary with respect to the chamber side plates,
a stationary gear mounted on the stationary shaft in the slot in the eccentric portion, and
a rotor rotationally mounted on the eccentric portion of the output shaft, the rotor comprising an internal gear configured to mesh with the stationary gear.

2. A rotary engine according to claim 1, wherein stationary shaft comprises an oil passageway configured to deliver oil to the interior of the rotor, or collect oil from the interior of the rotor.

3. A rotary engine accordingly to claim 1, wherein the output shaft comprises an oil passageway configured to delivery oil to the interior of the rotor, or collect oil from the interior of the rotor.

4. A rotary engine according to claim 1, wherein the rotor comprises
a rotor body comprising the internal gear,
at least one rotor carrier for mounting the rotor body on the eccentric portion of the output shaft, and
a lateral rotor oil seal arrangement for creating an oil seal between the output shaft and the rotor.

5. A rotary engine according to claim 4, lateral oil seal is formed by the lateral rotor oil seal arrangement contacting the output shaft and the rotor carrier.

6. A rotary engine according to claim 4, wherein the lateral oil seal arrangement comprises an oil seal carrier mounted on the output shaft, and an oil seal mounted on the oil seal carrier for creating a seal to the rotor carrier.

7. A rotary engine according to claim 4, wherein the rotor carrier comprises at least one shell bearing to run on the journal of the eccentric portion of the output shaft.

8. A rotary internal combustion engine, comprising
an output shaft rotationally mounted in two parallel combustion chamber side plates, the combustion chamber side plates and a combustion chamber wall defining a combustion chamber through which the output shaft runs, the output shaft comprising an eccentric portion positioned between the combustion chamber side plates within the combustion chamber,
a combustion stationary gear positioned within the combustion chamber coaxial with the output shaft, the combustion stationary gear being stationary with respect to the combustion chamber side plates,
a combustion rotor rotationally mounted on the eccentric portion of the output shaft, the combustion rotor comprising an internal gear configured to mesh with the combustion stationary gear,
an expander shaft rotationally mounted in two parallel expander chamber side plates, the expander chamber side plates and an expander chamber wall defining an expansion chamber through which the expander shaft runs, the expander shaft comprising an eccentric portion positioned between the expander side plates within the expander cavity,
an expander stationary gear positioned within the expander chamber coaxial with the expander shaft, the expander stationary gear being stationary with respect to the expander chamber side plates,
an expander rotor rotationally mounted on the eccentric portion of the expander shaft, the expander rotor comprising an internal gear configured to mesh with the expander station gear,
wherein the expander shaft and output shaft are coaxial.
